(19) United States
(12) Patent Application Publication
(10) Pub. No.: US 2006/0195808 A1
(43) Pub. Date: Aug. 31, 2006

(54) Method for correcting the optical proximity effect

(76) Inventor: Martin Keck, Muenchen (DE)

Correspondence Address: SLATER & MATSIL LLP, 17950 PRESTON ROAD, SUITE 1000, DALLAS, TX, 75252, US

(21) Appl. No.: 11/336,092

(22) Filed: Jan. 20, 2006

(30) Foreign Application Priority Data
Jan. 21, 2005 (DE) 10 2005 003 001.7

(51) Int. Cl. G06F 17/50

(52) U.S. Cl. 716/8; 716/21

(57) ABSTRACT

A respectively separate optical proximity correction (OPC) process model and method is formed for selected structure classes or partial patterns of a layout is disclosed. For this purpose, the corresponding structure elements are treated separately as early as during the modeling. During the modeling and also for OPC correction, the structure elements in the layout to be corrected are selected in correspondingly rule-based fashion. The thus selected elements of the layout are simulated and corrected with the separately formed OPC process models. The errors in the description of the imaging process are smaller for the separate OPC process models than for a uniform OPC process model, which has the effect of improving the accuracy of the imaging on the wafer in subsequent layout transfer processes.

This application claims priority to German Patent Application 10 2005 003 001.7 which was filed Jan. 21, 2005, and is incorporated herein by reference.

### TECHNICAL FIELD

The invention relates to methods for correcting the optical proximity effect when transferring patterns onto a substrate.

### BACKGROUND

In the case of high integration densities or very small structure widths, for example in the region of the resolution limit of a projection system, imaging errors often occur when transferring structures from a mask onto a wafer. If the structure elements are particularly close together, then this may also result, in particular, in undesirable and unavoidable light contributions of respectively adjacent structure elements in the photosensitive layer. These proximity effects, also called proximity errors, may be caused by instances of light scattering or diffractions at chromium or other absorber edges on the mask, lens imperfections, varying resist thicknesses or micro-loading effects, etc.

The imaging errors thus lead to deviations between the sizes and geometrical forms of structure elements in the pattern to be imaged which are actually formed on the wafer and those which are inherently desired by the designer in accordance with the layout that he has predefined. The layout is usually created in electronic form from a design according to the requirements of the integrated circuit to be produced and emerges from a plane-by-plane decomposition of the design. requirements of the integrated circuit to be produced and emerges from a plane-by-plane decomposition of the design.

In order to correct the deviations, a correction (Optical Proximity Correction OPC) is often applied in which, in the layout to be predefined, the data representing the sizes, positions and geometrical forms are modified in such a way that the structure elements are formed as desired after the transfer on the wafer. A data-technological compensation of the physical, i.e., optical and process-technological effects are thus involved.

Two fundamentally different approaches, by means of which an optical proximity correction is carried, out are known.

In the case of rule-based OPC correction, the concrete configurations within the pattern are read out individually in each case for structure elements in the layout. They include line widths, line distances, geometrical forms such as line ends or branchings, isolated or dense, periodic arrangements of structure elements, etc. These features are stored in a table through which they are assigned rules by means of which modifications are performed at the respective elements. By means of this method, the entire layout can gradually be covered and be modified for compensation of the proximity effects. The rules are adapted on the basis of experimental measurements.

In the case of the more complicated simulation- or model-based OPC correction, the modifications of the affected structure elements are calculated with the aid of a lithography simulator. This is a software program, which, on the basis of the predefined layout, simulates the operation of transfer from the mask on which the pattern of the layout is formed onto the wafer.

This simulation is based on a so-called OPC process model. The model unambiguously defines the imaging process. The model is characterized or represented by a set of model parameters. The model parameters may describe properties of the optical projection and also properties of the resist or of an etching process. They are allocated values that can be varied in a subsequent fitting process. It is also possible, of course, to keep them fixed, that is to say not enable them for adaptation.

The model parameters are determined by fitting the model results to experimental data. For this purpose, test patterns formed on a mask are first transferred onto a wafer. The structure elements formed in the process are measured in detailed fashion by means of measuring microscopes. The measured values, typically a few hundred, are then fitted whilst adapting the values for the enabled model parameters. The assumed physical relationships, on which the simulation is based and into which the model parameters are incorporated as variables, remain unchanged as such.

The actual OPC correction is then carried out on the basis of the model in iteration steps. The respectively corrected layout is used for calculating a new imaged pattern. The imaged pattern is compared with the desired pattern (e.g. the original layout), from which a new correction is then calculated. Since individual correction adaptations can interact with others, so that deviations still exist, a next iteration step may again become necessary. The iterations are ended only when there is a satisfactory match between the desired and a simulated layout.

However, in the present art, it is not always possible to describe the process of optically imaging the layout on the mask onto the wafer with sufficient accuracy by means of the OPC process model. The calculation of the corrections for layouts, which correspond to contact hole patterns shall be highlighted as a particular case. If the contact holes have a differing size, then they cannot be simulated and thus corrected simultaneously with identical precision. This is caused, in particular, by effects from the metrology area, that is to say those effects, which occur during the experimental measurement of the test pattern that was actually imaged at the outset. Moreover, mask or resist effects also come into consideration as causative.

The correction of line ends may be cited as a further example. The line end shortening that occurs precisely in the case of line widths in the region of the resolution limit of the projection system often cannot be simulated simultaneously with these line widths with sufficient accuracy in the context of an OPC process model, particularly when many different line widths are present.

A correction based on this inaccurate model therefore equally supplies erroneous results. Accordingly, down to a detailed examination and subsequent elimination or consideration of these effects that have hitherto been outside the model, deviations between desired and actually imaged structure elements are still to be expected.

A residual error during the OPC correction for selected structure classes and thus deviations from the desired pattern during the transfer onto the wafer had hitherto been accepted. A continuing need, thus, exists for effective methods of correction that overcome the limitations of the prior art. The embodiments of this invention disclosed herein address this need.

### SUMMARY OF THE INVENTION

Therefore, the embodiments of the invention provide an OPC correction method for use in patterning a wafer, which improves the quality of the correction. In particular, for layouts with structure elements having differing size, form and mutual distances, preferred embodiments of the invention obtain simultaneously a high match between desired and actually obtained results for the projection on the wafer.

Advantages are achieved by means of a preferred method for correcting the optical proximity effect when transferring patterns onto a substrate. This method includes the steps of predefining the electronically stored pattern having at least one first and one second structure element, predefining a rule by means of which arbitrary structure elements are selected in a manner dependent on their geometrical form, length, width or their distance from an adjacent, further structure element and are subdivided into classes. The method further includes applying the rule to the pattern, so that the first structure element is assigned to a first class and the second structure element is assigned to a second class of structure elements in each case by rule-based selection. The method continues by applying a first simulation model for correcting the optical proximity effect, which is represented by a first set of model parameters, to the structure element of the first class, applying a second simulation model for correcting the optical proximity effect, which is represented by a second set of model parameters, to the structure element of the second class. The first structure element and the second structure element are then in each case adapted in terms of their geometrical form and size. The first and the second sets of model parameters being chosen to be different. The pattern is then stored with the structure elements adapted for correcting the optical proximity effect and for transferring the stored pattern onto the substrate.

Additional advantages are achieved by means of a preferred method for correcting the optical proximity effect when transferring patterns onto a substrate. In this method, the steps are predefining the electronically stored pattern having at least one first and one second structure element, predefining a rule by means of which the pattern can be subdivided into at least one first and one second, in each case contiguous, partial pattern, applying the rule to the pattern for decomposition into the two partial patterns in such a way that the first structure element is arranged in the first partial pattern and the second structure element is arranged in the second partial pattern. The method continues by applying a first simulation model for correcting the optical proximity effect, which is represented by a first set of model parameters, to the structure element in the first partial pattern, applying a second simulation model for correcting the optical proximity effect, which is represented by a second set of model parameters, to the structure element in the second partial pattern, so that the first structure element and the second structure element are in each case adapted in terms of their geometrical form and size. In the method, the first and the second set of model parameters being chosen to be different. The pattern is stored with the structure elements adapted for correcting the optical proximity effect. Finally, the method is completed by transferring the stored pattern onto the substrate.

The preferred embodiment solutions proposed herein correspond to one another, apart from the difference in that the first case involves correcting structure classes, and the second case involves correcting partial patterns or layout regions with different OPC process models. In so far as the partial patterns are, in each case, composed of structure elements of a specific structure class, there is correspondence between the two solutions proposed.

With a structure class, structure elements are subdivided into classes of a defined geometrical form and size. For a technology characterized by a minimum feature size that can be produced, e.g. 70 nm technology, by way of example, contact hole geometries of identical width but differing length are subdivided according to their length. Classes primarily arise not by creating arbitrary lengths for contact holes in the layout, but rather, by defining lengths available in gridlike fashion, such as 100 nm, 200 nm, 300 nm, etc. Structure elements of a structure class to which precisely one of the two OPC models is applied may be present in contiguous fashion, or in a manner widely distributed in the layout.

A partial pattern or layout region as described herein denotes both functionally and spatially contiguous regions in the layout. This includes, in particular, arrangements with structure elements that recur periodically or are arranged in gridlike fashion. Partial patterns or layout regions may also be defined by a common rule, for instance, a maximum or minimum structure width applicable to the region, or a corresponding maximum or minimum permissible structure distance, which is applicable or present only for this region.

An important aspect is that on the basis of a rule, an unambiguous selection, for example, by means of a so-called design rule check (DRC), of precisely the elements of a predetermined structure class or of a predetermined partial pattern from the overall pattern takes place, whereas other elements are initially not selected. However, a selection may also be performed by means of specially marked areas, for instance, of a so-called marking layer present in the hierarchical file format.

Thus, the rule corresponds to one such as is conventionally used for rule-based OPC correction. Ina preferred embodiment, it is executed on an electronically stored pattern. The pattern may be present as a layout, for example, in the hierarchical GDS II format.

In one preferred embodiment, a first OPC process model is used, then, for the structure elements of a first structure class or of a first partial pattern that are selected in rule-based fashion. The first OPC process model is characterized by a first set of model parameters. To put it more precisely, it is characterized by a first combination of values for the model parameters.

Structure elements of a second class or of a second partial pattern, which are different from the elements of the first class or of the first partial pattern, are also selected on the basis of the same or a further rule. This may also simply involve the remaining elements of the overall pattern, which are not selected by the same rule, and the commonality of which consists in not belonging to the first structure class or to the first partial pattern.

A second OPC process model is selected for this second class, or the second partial pattern. The combination of values of this second process model for the model parameters differs from that of the model of the first class, or of the first partial pattern. The difference in the value of a single model parameter may suffice.

The values for the model parameters are optimized by individual adaptation to experimental data to the respective classes, or partial patterns. OPC correction iterations are then carried out separately for the two classes or patterns, the corresponding OPC process model being used in each case.

The advantage of the use of the invention arises from the fact that mutually independent fitting procedures can be carried out from the outset for the respective structure classes or partial patterns. The problems of a uniform process model can be reduced in this case, by virtue of the fact that the accuracy of the correction is improved when using different OPC process models. An OPC model with a smaller residual error can be formed for a subset of the design structures.

The weight of the effects, which arise as a result of influences that have not been taken into account hitherto, such as resist or other process effects, thereby diminishes even if they continue to exist to a small extent. The disadvantageous influence even of long-range optical effects, such as so-called flares, which can scarcely be taken into account in the OPC process model of the prior art, can thereby be at least reduced.

The result is an improvement in the accuracy of the OPC correction and a corresponding increase in the quality of the imaging of the layout onto the wafer. This improvement in turn leads to an increase in the overall yield. The improved OPC correction may be used to produce a stored pattern that may be transferred onto a semiconductor wafer. Subsequent semiconductor processing steps are then applied to produce integrated circuits using the accurate pattern. The wafer may then be subjected to conventional back end processes such as device test, singulation and packaging to produce completed integrated circuit devices.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 shows, by way of example, the sequence of the method according to the invention in a flow diagram;

FIG. 2 shows a test mask with contact hole elements of different structure classes arranged thereon;

FIG. 3 shows a test mask with structure elements of different partial patterns arranged thereon; and

FIGS. 4-6 show the results of a simulation of the projection of contact holes onto a wafer in comparison with measurement results determined experimentally: with a uniform OPC process model (FIG. 4), with a separate model for double contact hole elements (FIG. 5), and with a separate model for other contact hole elements (FIG. 6).

The following list of reference symbols can be used in conjunction with the figures:
10 Mask
20, 22 Structure classes
30-32 Partial patterns
102 Predefining a layout
104 Predefining a rule
106 Rule-based selection
108 OPC correction with first model
110 OPC correction with second model
202 First OPC process model
204 Second OPC process model
211-215 Structure elements of the first class “Double contact hole elements”
221-225 Structure elements of the second class “Single contact hole elements”

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

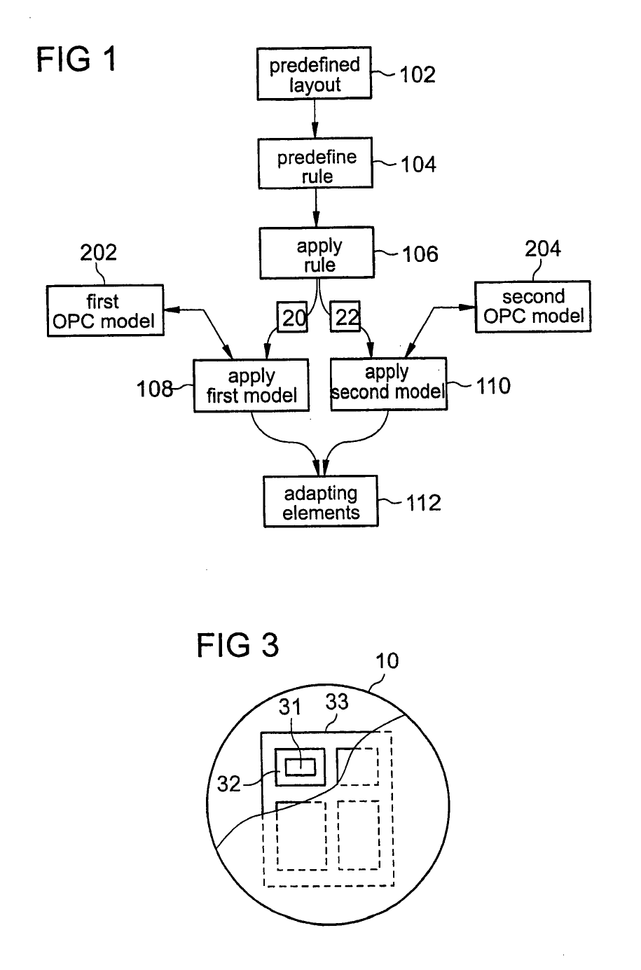

FIG. 1 shows, by way of example, the sequence of the method according to a preferred embodiment of the invention in a flow diagram. First, a layout for producing a mask plane is predefined (step 102). The layout has been extracted, for example, beforehand from the overall design of an integrated circuit.

The application of the further method is based on the knowledge that the concrete layout poses problems when projecting a mask onto a wafer. In particular, it has been found that the dimensions of the structures that have hitherto been OPC-corrected by means of a uniform model do not match the dimensions originally provided. In this case in particular, a layout is present that has structure elements having critical widths and mutual distances which, however, vary considerably in terms of their form or density over the layout.

This illustrative example concerns a contact hole plane, which has contact hole elements of identical width, but different length and density with regard to the distances from adjacent contact hole elements.

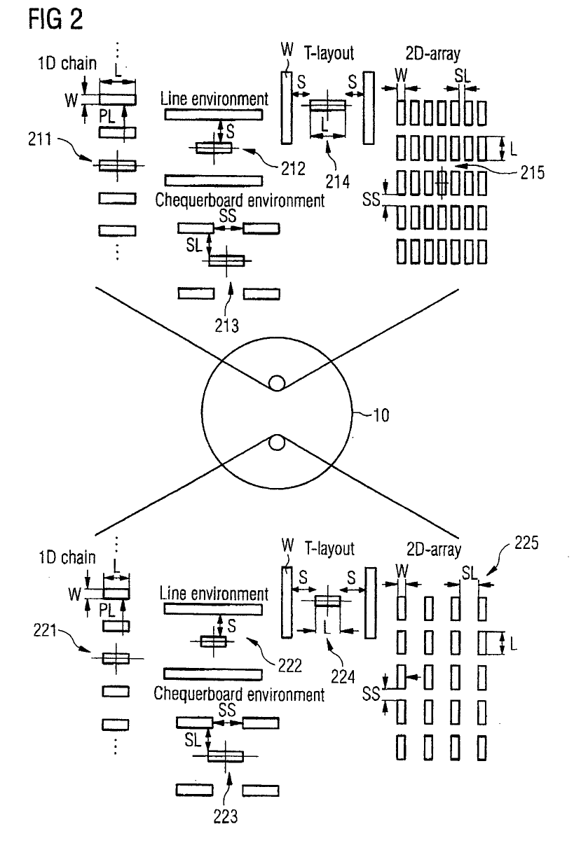

A further step 104 involves predefining a rule, which can subdivide the contact hole elements according to the criterion of length and/or density of the arrangement. FIG. 2 illustrates some of the contact hole arrangements that are formed on a mask 10 in a common layout. On the basis of the rule, the distances S, SS, SL, the critical widths W, WL, the lengths L and the pitches PL can be determined in the associated electronically stored layout. Typical CAD (Computer Aided Design) programs have an implementation of software routines, by means of which the contact hole elements can be identified, and the corresponding dimensions can be determined.

In the present example, “double contact hole elements”, that is to say, contact hole elements of a specific length class are identified by the rule predefined in step 104 and are measured in the layout.

In step 106, the rule is correspondingly applied to the layout. Longer “double contact hole elements” 211-215 are identified for this purpose, selected and assigned to a first structure class 20. All other contact hole elements 221-225 that do not fall into the length class of the double contact hole elements (in this example, the shorter “single contact hole elements”) are assigned to a second structure class 22 (FIG. 2).

FIG. 2 shows a test mask 10. In order to create one or more OPC models for the next step, the layout with the structure elements of the different length classes is formed beforehand on the test mask 10, the layout is converted into a mask writer-enabled format and drawn on a mask coated with a resist. Test patterns of the double contact hole elements 211-215 are schematically illustrated in the upper part of the mask 10 and test patterns of the single contact hole elements 221-225 are schematically illustrated in the lower part of the mask 10.

The test patterns are in each case provided with their English language designation known among experts: “1D-chain”, “line environment”, “chequerboard environment”, “T-layout”, “2D-array”, for example. The orientation of the further elements surrounding a contact hole element and their distance from the contact hole element can have a considerable effect on the imaging properties. By contrast, the orientation of the individually designated test patterns on the mask 10, or the mutual distance along one another, is unimportant in this example.

With the mask 10 a substrate is exposed in an exposure device. The structure elements, for example, contact hole elements, transferred onto the substrate are subsequently supplied to a measuring microscope and measured there. The quantities W, L, S, SS, SL etc. designated in FIG. 2 are measured, by way of an illustrative example.

In the case of the prior art, for the model all the measured values W, L, S, SS, SL, etc., are then used for the fitting of the model parameters. This fitting procedure comprises an optimization of the model parameters, e.g. in such a way that the deviations of the measured individual values from the values obtained from a simulation with the model parameters to be optimized are minimized in an X² test.

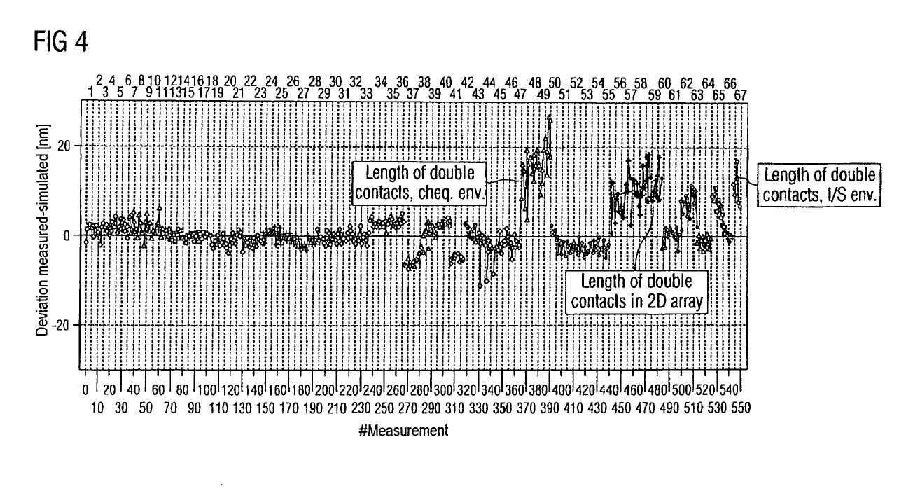

The result can be seen in the diagram of FIG. 4. The deviation between the measured and the simulated length of the contact hole elements is plotted (y axis). The individual test patterns for which the deviations were determined are plotted, and combined in groups on the x axis. For each test pattern, the quantities W, L, S, SS, SL were also varied as input parameters, so that a plurality of deviation values could be determined for one test pattern type.

The measurement points for the test patterns designated in detail in FIG. 2 are marked by arrows. The results for the class of the double contact hole elements deviate, for the set of finally fitted model parameters, significantly from those of the “single contact elements” and other contacts. The mean square error of this uniform OPC model is 3.4 nm.

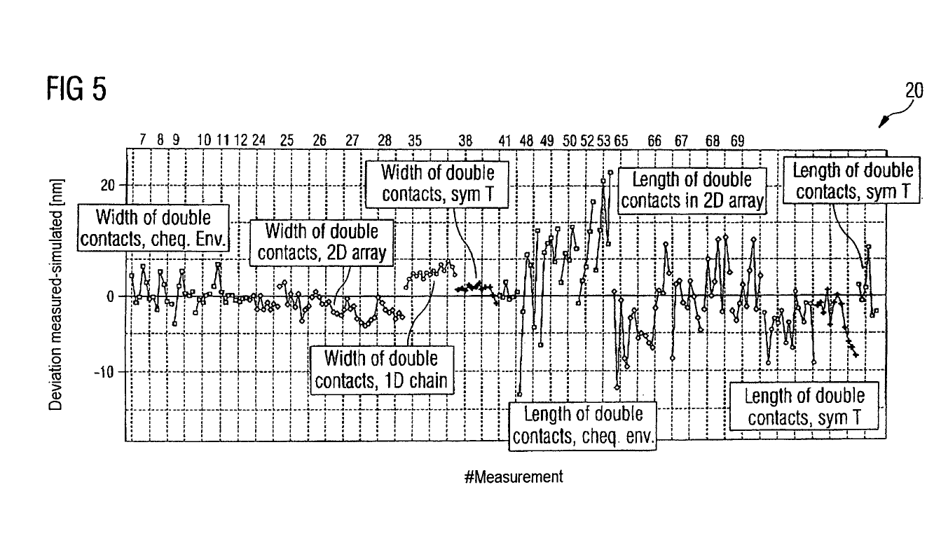

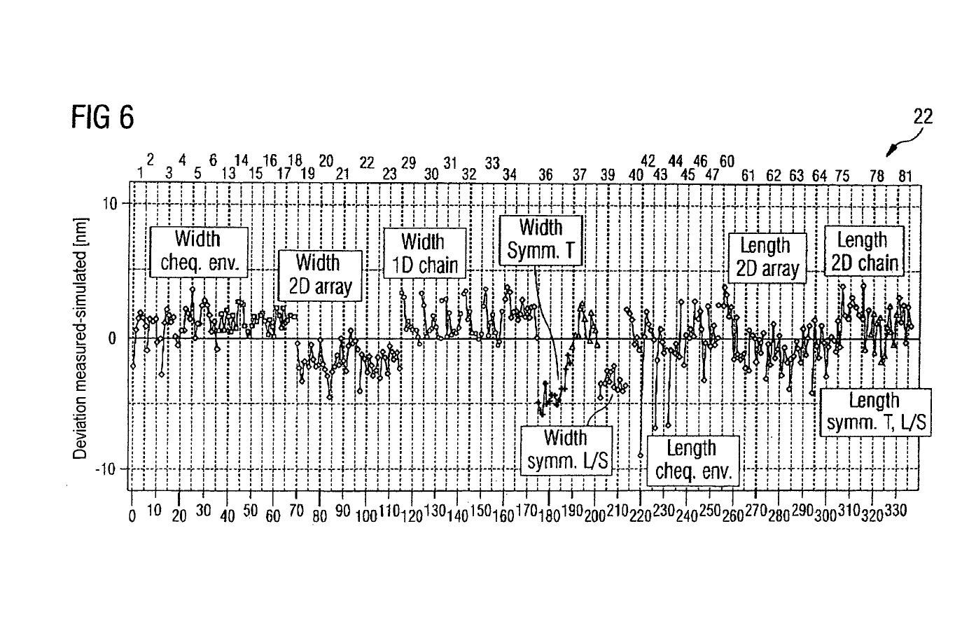

FIGS. 5 and 6, by contrast, show the procedure according to a preferred method of the invention: the corresponding results of the double contact hole elements 221-225, subdivided into the structure class 20 through application of the rule, are plotted in FIG. 6. The results for the single contact hole elements 221-225 of the structure class 22 that were simulated and fitted separately therefrom are plotted in FIG. 5. The respectively determined mean square error of 2.8 nm (structure class 20) and 2.1 nm (structure class 22) is considerably reduced as compared with the uniform model of the prior art.

The two sets of model parameters optimized separately to their experimental data represent two different OPC models 202, 204 which, however, are both assigned to the same overall layout.

Further steps 108, 110, which are to be carried out separately, involve applying the two separately calculated OPC models 202, 204 for carrying out the OPC correction. In this preferred embodiment method, however, only the affected contact hole elements are in each case corrected, that is to say, provided with a bias or so-called hammerheads in the same layout. That is to say, single contact elements 221-225 of the layout are not corrected by the OPC method according to step 108, in which the OPC model 202 optimized for the double contact hole elements is taken as a basis for the simulation. Moreover, the single contact elements are only corrected in accordance with the OPC method according to step 110, which is based on the associated OPC model 204. In step 112, adapt the first and second structure elements in terms of their geometrical form and size according to the application of the first and second simulation models.

A further exemplary embodiment of the invention relates to the use of a respectively separate OPC process model for the correction of line ends during the simulation-based OPC correction. This is to be understood not as corrections of the line widths, but rather, as those corrections that compensate for the line end shortening that often occurs. It can be used to affect, according to a preferred embodiment of the invention, such a compensation at line ends with a subdivision of the line elements into structure classes. Aspects of the class subdivision for the purpose of the individually adapted OPC models are, in this case, the line width or the distance between the end and further lines, as examples.

A further exemplary embodiment relates to the use of separate OPC models for the correction of long-range effects for selected layout regions, or partial patterns. One example can be seen depicted in FIG. 3. Long-range effects having ranges of more than 1 μm, such as, for instance, the influence of scattered light (so-called flares) cannot be corrected in a conventional manner with a single OPC process model, with which typical ranges in the region of a few μm are simulated. By dividing the layout into regions having differing scattered light influence and applying corresponding OPC correction with separate OPC models, a correction of long-range effects is thus also possible.

The example shown in FIG. 3 relates to a mask plane for producing active areas in a memory component. Since, on average, less light passes through the mask in the region of the memory cell array 31, but all the more light passes in the lead and peripheral region 33, the outer region 32 of the array is affected by the scattered light of the periphery to a greater extent than the interior of the memory cell array. Therefore, the rule-based selection (step 106) can perform an advantageous grouping into partial patterns 31-33, for which different OPC process models are formed.

A further exemplary embodiment of the invention provides for establishing separate OPC process models for layout regions with a different foundation. The rule-based selection of gate electrodes, depending on whether they are formed above active areas or isolation trenches, is an example.

A further exemplary embodiment provides the use of separate OPC process models for different proximity or linearity regions of a layout. This preferred method includes the selection of structure elements according to the aspect of the structure width, that is to say, local design rules. Thus, it is possible, for instance, staying with the illustrative example of the memory component of FIG. 3, to provide in each case a separate OPC process model for the cell region (array edge), the edge region (core) with the MUX gap (MUX: abbreviation for multiplex), and the further logic wiring (periphery).

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for correcting an optical proximity effect when transferring a pattern onto a substrate, comprising:
predefining an electronically stored pattern having at least one first and one second structure element,
predefining at least one rule wherein arbitrary structure elements are selected in a manner dependent on at least one of their geometrical form, length, width and their distance from an adjacent, further structure element, and are subdivided into classes;
applying the at least one rule to the pattern, so that the first structure element is assigned to a first class and the second structure element is assigned to a second class of structure elements in each case by rule-based selection;
applying at least a first simulation model for correcting the optical proximity effect, which is represented by a first set of model parameters, to the structure element of the first class;
applying at least a second simulation model for correcting the optical proximity effect, which is represented by a second set of model parameters, to the structure element of the second class;
whereby the first structure element and the second structure element are in each case adapted in terms of their geometrical form and size;
the first and the second set of model parameters being chosen to be different in one or more aspects; and
storing the pattern with the structure elements adapted for correcting the optical proximity effect.

2. The method of claim 1, in which the first and the second structure element have at least one mutually different placement selected from the group of length and width and a different distance from adjacent structure elements.

3. The method of claim 1, in which the first and the second structure element in each case represent contact hole openings for an integrated circuit.

4. The method of claim 1, in which the first and the second structure elements in each case represent line ends of an integrated circuit.

5. The method of claim 1, in which the step of predefining the rule further comprises the selection of such a rule, which performs a rule-based selection of an arbitrary structure element and the subdivision thereof into a class additionally in a manner dependent on at least one of the geometrical form, length, width and the mutual distance of such structure elements, which are situated in a further pattern at the position relating to the arbitrary structure element, the further pattern representing a layer plane of the same integrated circuit plane as that layer plane of the predefined pattern.

6. A method for correcting an optical proximity effect when transferring a pattern onto a substrate, comprising:
predefining an electronically stored pattern having at least one first and one second structure element;
predefining a rule, by means of which, the pattern can be subdivided into at least one first and one second, in each case contiguous, partial pattern;
applying the rule to the pattern for decomposition into the at least one first and one second partial patterns, the first structure element being arranged in the first partial pattern and the second structure element being arranged in the second partial pattern, applying a first simulation model for correcting the optical proximity effect, which is represented by a first set of model parameters, to the structure element in the first partial pattern;
applying a second simulation model for correcting the optical proximity effect, which is represented by a second set of model parameters, to the structure element in the second partial pattern;
wherein the first structure element and the second structure element are in each case adapted in terms of their geometrical form and size;
the first and the second set of model parameters being chosen to be different; and
storing the pattern with the structure elements adapted for correcting the optical proximity effect.

7. The method of claim 6, in which the step of predefining a rule further comprises the selection of such a rule which performs the subdivision into contiguous partial patterns depending on at least one parameter selected from the group of: the width, length, the mutual structure element distance, and the geometrical form of structure elements in regions of the pattern.

8. The method of claim 1, having the further step of transferring the stored pattern onto the substrate, comprising:
forming the pattern on a mask; and
projecting the pattern from the mask onto the substrate.

9. The method of claim 1, having the further step of transferring the stored pattern onto the substrate, comprising directly drawing the pattern by means of an electron or particle beam on the substrate.

10. The method of claim 1, in which the first and the second set of model parameters differ in the values of at least one model parameter.

11. The method of claim 1, in which the model parameters of the first and second sets are in each case defined by:
transferring the pattern with the first and the second structure elements onto the substrate;
measuring at least one of the geometrical form, the length and width and a mutual structure element distance from further, adjacent structure elements, and predefining a first selection for the model parameters in each case for the simulation of the transfer of the first and the second structure element;
respectively carrying out a simulation of the transfer of the pattern for the first and the second structure element;
respectively comparing the result of the simulation with the measurement;
respectively adapting the model parameters in a manner dependent on the comparison; and
repeating the steps “carrying out a simulation” to “adapting the model parameters” in each case in a manner dependent on the comparison result.

12. The method of claim 11, in which the step of carrying out a simulation involves taking account of long-range effects with a length of action of more than 1 micrometer during the transfer onto the substrate.

13. The method of claim 12, in which a locally different action of scattered light on the substrate is taken into account as a long-range effect.

14. The method of claim 6, having the further step of transferring the stored pattern onto the substrate, comprising:
forming the pattern on a mask; and
projecting the mask onto the substrate.

15. The method of claim 6, having the further step of transforming the stored pattern onto the substrate, comprising directly drawing the pattern by means of one of an electron beam and a projecting beam on the substrate.

16. A method for manufacturing a semiconductor wafer, comprising:
providing a semiconductor wafer substrate;
providing an electronically stored pattern having at least one first and one second structure element to be formed on the semiconductor wafer, which pattern may exhibit at least one optical proximity effect when transferred to the wafer;
predefining a rule by means of which arbitrary structure elements are selected in a manner dependent on at least one of their geometrical form, length, width and their distance from an adjacent, further structure element, and are subdivided into classes;
applying the rule to the pattern, so that the first structure element is assigned to a first class and the second structure element is assigned to a second class of structure elements in each case by rule-based selection;
applying a first simulation model for correcting the optical proximity effect, which is represented by a first set of model parameters, to the structure element of the first class;
applying a second simulation model for correcting the optical proximity effect, which is represented by a second set of model parameters, to the structure element of the second class;
whereby the first structure element and the second structure element are in each case adapted in terms of their geometrical form and size,
the first and the second set of model parameters being chosen to be different in at least one of the model parameters;
storing the pattern with the structure elements adapted for correcting the optical proximity effect; and
transferring the stored pattern onto the wafer substrate.

17. The method of claim 16 wherein the step of transferring the stored pattern comprises:
forming the stored pattern as a mask; and
projecting the pattern from the mask onto the wafer substrate.

18. The method of claim 16 wherein the step of transferring the stored pattern comprises forming a pattern on the semiconductor wafer by directly patterning the stored pattern onto the surface of the wafer substrate by use of one of an electron beam and a particle beam.

19. The method of claim 17 and further comprising processing the semiconductor wafer using the pattern to complete a multiplicity of integrated circuits.

20. The method of claim 18 further comprising processing the semiconductor wafer using the pattern to complete a multiplicity of integrated circuits.
